(19) United States
(12) Patent Application Publication
(10) Pub. No.: US 2007/0205529 A1
(43) Pub. Date: Sep. 6, 2007

(54) SEPARATION OF PLASTIC AND ELASTOMERS FOR FOOD AND PHARMACEUTICAL PRODUCTS

(76) Inventors: Donald Bruce May, Upwey (AU); Sharon May, Upwey (AU)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 11/573,910

(22) PCT Filed: Sep. 8, 2005
(86) PCT No.: PCT/AU05/01366

§ 371 Date: Feb. 19, 2007

(30) Foreign Application Priority Data
Sep. 9, 2004 (AU) 2004905185

(51) Int. Cl. B07C 5/344; C08K 3/10

(52) U.S. Cl. 264/173.16; 524/435; 209/636

(57) ABSTRACT

Contaminants in food or pharmaceuticals derived from the handling equipment are detected by known detection devices in product flow by the method of detecting particulate magnetic mineral dispersed in the handling equipment or the film used to wrap the food. The minerals magnetic field is detected and the signal generated thereby causes rejection of the product which contains the contamination. A method of making moulded parts of the handling equipment and wrapping film by incorporation of ferrimagnetic ceramic fillers is disclosed. Compositions for moulding and film extrusion with 10-50% of magnetite and other magnetic fillers with a size range of 0.5-20μ are disclosed.

### FIELD OF THE INVENTION

This invention concerns methods for removing physical contamination from food or pharmaceutical products in a product flow.

### BACKGROUND OF THE INVENTION

Physical contamination in the food and pharmaceutical industry exposes the manufacturer to unacceptable financial risk exposure due to the cost of product recalls, the cost of litigation and injury to consumers, loss of confidence by consumers and re-sellers leading to the loss of business, and penalties associated with non-compliance with standards and regulations.

Examples of the type of contamination which specially concern the industry are failures of working parts in mixers, blenders, extruders and the like, resulting in fragments of machinery being liberated into the product. Breakage of fibreglass trays in confectionery factories leads to contaminants of plastic and glass fibres in lollies and cooked jellies. Packaging of meat in plastic bags which are subsequently frozen may adhere or entrap the plastic which tears from the bag and remains attached to the meat itself. Unforseen failures such as bristle shedding from brushes may make detection even harder. The penalties exacted by some companies for infractions of this type can be severe, resulting in loss of further business.

In the prior art, U.S. Pat. No. 6,113,482 and U.S. Pat. No. 6,177,113, advocate the dispersion of 5% stainless steel, shavings, filings or powdered metal particles in all plastic food machinery components which are likely to fail and provide an example of a scraper. The purpose of the metal was to generate a signal in a metal detector which would indicate plastic contamination was present.

The limitation of this approach is that metal detection equipment is only capable of detecting what I consider a large fragment of 15×15×2 mm (as indicated on the B.S. Teasdale web site). Contaminants smaller than this still present an unacceptable risk of food recall and injury to the consumer. So a considerable improvement in the minimum detectable size is required.

In the prior art, U.S. Pat. No. 6,113,482 and U.S. Pat. No. 6,177,113, advocate the dispersion of 5% stainless steel, shavings, filings or powdered metal particles into plastic film wrap to enable the detection of fragments in the food. The limitations of this approach is that the film would have to be significantly larger than the example of a scraper fragment to contain the equivalent metal content to activate the metal detector. A 15 mm×15 mm×2 mm scraper is equivalent to a 105 mm×105 mm×40 μm piece of plastic film.

In addition, stainless steel filings, swarf and powders are poorly suited as inclusions in plastic film. The large particle size of the stainless versus the film thickness, the particles irregular shape and abrasive nature of the particles are unsuitable for the manufacture of a film based product. The combination of the above issues possibly explains why there is not a commercially available product. A film product that can be commercially manufactured with improved performance is required.

Although the prior art U.S. Pat. No. 6,113,482 and U.S. Pat. No. 6,177,113 indicates that the detection rate may be improved by increasing the percentage of particles, there are two disadvantages. Firstly the cost of the metal particles is relatively high and secondly the risk of contamination by the stainless steel particles themselves increases. Manufacturers spend considerable effort trying to prevent contamination of their products from stainless steel filings as a result of equipment wear because it is a hazard and do not want to add these same contaminants into a plastic into which they are poorly held for them to also act as contaminant in the food product. A safer alternative is required to solve this issue.

In my co-pending application for patent WO 03/045655 A1, metal particles referred to above are replaced by magnetic mineral particles of much smaller physical size. They are dispersed in ordinary moulding polymers and made into food machinery components, for example moulded trays for carriage of starch in confectionery production lines. If the handling machinery breaks a tray, even small fragments (1 mm in size and less) contain sufficient magnetite to render them separable from the recycled starch and the food by magnetic attraction.

The magnetite is present in a greater percentage and the particles are rounded and of the order of 0.1 to 100 μm in diameter. They are considerably cheaper than metal particles, non-toxic and not physically invasive to humans if accidentally ingested and not abrasive to machinery when they are compounded into moulding compositions. The magnetic susceptibility changes the process from one of detection to one of physical separation. The fragments containing the mineral collect on the magnet which hunts continuously for contaminants. It is possible to disperse the magnetite in plastic film because the mineral is very finely ground or manufactured synthetically by precipitation down to 0.1 μm. Manufacturers can by simply fitting components made of polymer compositions containing about 10-50% of the mineral, expect significantly improved protection against physical contamination. Particles of 1 mm and less can be removed by a magnet.

The limitation of the co-pending application for patent WO 03/045655 is that it is restricted to applications where the contaminant is in free flowing powders, granules, liquids, where close proximity between the magnet and contaminant can be achieved. It is not suitable for applications where the contaminant is embedded in the product or is enclosed in a food package, where the field strength of the magnet is insufficient to remove both the packet and the enclosed contaminant.

### SUMMARY OF THE INVENTION

The method aspect of the invention provides a method of detection and removal of physical contamination from food products or pharmaceutical products in a product flow, wherein the source of contamination is plastic or elastomer food processing or handling equipment which contains dispersed magnetic mineral materials as herein defined, comprising subjecting the food or pharmaceutical product to metal or magnetic field detecting equipment deriving a signal and utilising the signal to divert the product from the flow.

The material chosen to enable the detection and removal of physical contaminants is chosen from the ferrimagnetic ceramics. These ionic materials are often called cubic ferrites and may be represented by the chemical formula MFe₂O₄ in which M represents any one of several metallic elements such as Ni, Mn, Co, Cu. Cubic ferrites having other compositions may be produced by adding metallic ions that substitute for some of the iron in the crystal structure. Thus, by adjustment of the composition, ferrite compounds having a range of magnetic properties may be produced. Ceramic materials other than cubic ferrites are also ferrimagnetic; these include the hexagonal ferrites and garnets. The chemical formula for these materials may be represented by the AB₁₂O₁₉ in which A is a divalent metal such as Barium, Lead or strontium and B is a trivalent metal such as aluminium, gallium, chromium or iron. The two most common examples of the hexagonal ferrites are PbFe₁₂O₁₉ and BaFe₁₂O₁₉. The saturation magnetizations for ferrimagnetic materials are not as high as for ferromagnets. Although ferrites being ceramic materials are non conductive.

The preferred embodiment of the invention is the ferrite Fe₃O₄ or otherwise known as the mineral magnetite or lodestone. This is a naturally occurring mineral, although it can also be produced synthetically.

Magnetite has a number of advantages. The first of which we shall discuss is that it is generally recognised as safe. Magnetite is essentially non-toxic. It is permitted as a food colorant by the FDA. When incorporated into plastics it has been tested and passes FDA and EEC food contact requirements, which is based on the migration of the mineral into the food. Magnetite is actually found in and used by birds as an internal compass to navigate by and may be used as a food supplement for animals deficient in Iron.

The fabrication of components from polymers and the ferrimagnetic ceramic—magnetite present no chemical hazard.

Magnetite is a naturally occurring mineral which is mined and ground to suitable sizes for a range of industrial applications from 100 to 1 μm. It also may be produced synthetically, particularly where high purity and ultra fine particle sizes, for example 0.6 μm are required.

A feature of Magnetite is that it produces a regular rounded shape, available in such ultra fine particles as shown in FIG. 2. The advantages of this are many, one advantage is that it is not physically invasive. By comparison, Stainless Steel powders as described in the Background of the Invention are considerably larger and present a sharp hazard, which is a potential site of infection.

The use of non toxic and non invasive Magnetite ensures that the components fabricated from a polymer and Magnetite does not pose an increased risk greater than the polymer itself. This is of particular importance for fragments of components that are too small to be detected and removed or in the detection equipments failure mode that the public is not exposed to an added risk.

A further feature of Magnetite is the size, shape and with a Specific Gravity of 5.0. This enables excellent dispersion in comparison to metals as discussed in Background of the Invention which suffer from poor dispersion. Individual particles are clearly not visible in fabricated components.

A further feature of Magnetite is the low cost of manufacture. Magnetite is either ground from naturally occurring minerals or by being prepared synthetically, is cheap in and can act as a low cost filler. Particularly in comparison to speciality metals used in the prior art as discussed in the Background of the Invention.

A further feature of Magnetite is that it is a mineral. A whole range of minerals are routinely compounded and moulded into polymers to act as filler or to provide a technical effect. It is no more abrasive than many other types of filler and hence presents no undue increase in wear and maintenance costs over other mineral filler polymers. By contrast, metals as discussed in Background of the Invention present a significant increase in maintenance cost due to wear.

The methods of compounding and moulding polymeric based compounds is wide and varied so only those given in the Examples are provided for the polymer/magnetite matrix.

An issue that needs to be taken into account in the design of the component is the physical properties of the polymer by itself will not be the same as the polymer/magnetite matrix. By comparison the prior art claims that the use of between 1% and 5% particulate metal being of a size and shape that no perceptible effect on the structural integrity of the piece part results is possible. But any more is likely to have an effect. The use of between 10% to 50% of magnetite will affect the properties of the plastic. In some cases this will not be a significant issue as the magnetite may be used to substitute for existing mineral fillers. In other cases as the effects of adding mineral fillers is well known, simple design changes of the component parts can be made at the design stage or by the addition of other additives or the use of alternative polymers overcome these design issues.

The ferrimagnetic ceramic is compounded into the polymer, typically in the range of 10%-50% by weight. The formulation being dependant upon the design compromises made to suit the application which can include cost, type of polymer, physical properties, product effects, minimum acceptable detection limit, to name a few.

It has been found that formulations with approximately 30%-35% by weight of Magnetite in a polymer can approach the minimum detectable size comparable to 100% Stainless Steel metal components. Such as the industry standard of a 2.0 mm Stainless Steel Sphere. This level of detection is not possible with the prior art discussed in the Background of the Invention, which contains only approximately 5% Stainless Steel.

Metal detectors are routinely used to detect metal contamination from equipment, hence the incorporation of metal into plastics to detect fragments of plastic by the prior art. But as discussed in the Background of the Invention, the minimum detectable size by this method is unacceptable.

Ferrimagnetic ceramics can provide a significant improvement in the prior art. The reasons for this are a result of the properties of the different materials. All metals are conductive, the first group which are called non-ferrous include Copper, Gold, Silver, Aluminium, etc. which are called Paramagnetic or Diamagnetic are non magnetic. When exposed to the electromagnetic fields of a metal detector, it induces a current in the metal, which in turn induces a magnetic field around the metal, which interacts with the balanced coil configuration to produce a signal.

The ferrimagnetic material may be finely ground or formed by precipitation with a particle size between 0.1 μm and 100 μm. The ferrimagnetic material may be typically present in the range 10-50% by weight, that is 10, 15, 20, 25, 30, 35, 40, 45, 50%.

The ferrimagnetic materials are naturally magnetic but their properties may be enhanced by the application of a magnetic field prior to, during or after moulding. The detection device may be a commercially available metal detector. The plastic or elastomer is preferably within the group already used in the food industry in that they are suitable for food contact. The ferrimagnetic material is typically homogeneously mixed with the plastic or elastomer to form the plastic or rubber component. A variation can include a co-extruded layer, or other suitably bonded plastic or rubber layer to provide a boundary layer between the food and the detectable layer or to achieve some other technical effect such as colour, chemical exclusion, to name a few. An example includes a vacuum pack CRYOVAC™ bags produced from a plastic film which consist of a boundary layers to prevent oxygen ingress spoiling the food and a detachable core layer. For meat bags, the film will appear black and be 25-80μ in thickness.

Examples of products manufactured for the food and pharmaceutical industry may include containers, trays, conveyors, rollers, brushes, scrapers, bags, films, seals, covers, gloves and surgical dressings.

Briefly a metal detector is an electronic device that has a coil driven by an alternating electric current that generates an oscillating magnetic field and a pair of detection coils connected in a precision balanced circuit.

For purely conductive materials such as (a) some foods with high levels of water and salts such as meats and cheese, and (b) non-ferrous metals such as Al, Pb as the magnetic field pulses back and forth it interacts with any conductive object it encounters causing them to generate weak magnetic fields of their own, when the receiver coil passes over an object giving off a weak magnetic field a small current travels through the receiver coil, which is out of phase with the drive coil and hence generates a signal that can activate a rejection device. This signal is illustrated by a line on the impedance plane in FIG. 4C, whose angle depends on the conductivity of the object.

For Ferrous Metals (Fe, Co, Ni) the shape of the response is complicated by the combination of conductive response and ferromagnetic response as a result of becoming magnetised in the metal detectors field (see FIG. 3C).

Ferrimagnetic Materials (Fe₃O₄, etc.) by comparison are not electrically conductive and produce a straight line response due to magnetic field of the material which is differentiated from conductive materials by its phase angle (see FIG. 5C).

Metal detectors can detect any conducting items including food items such as hot bread, meat products and cheese. These food items which are weakly conductive can have an effect on the detector many times larger than that due to the size of the metal sample that it is required to detect. This is called product effect. The effect arises because of the eddy currents flowing in the product itself, particularly where it is of a moist salty nature is weakly conductive.

The enormous size of the food in comparison to the metal particles makes the effect considerable. Hence the metal particles may not be detected except for large particles.

Ferrimagnetic materials as discussed are non conductive and hence produce a measurably different response even if the foods are electrically conductive. Metal detection devices such as described in U.S. Pat. No. 5,304,927 can be calibrated to detect the background signal of the food and readily identify the effects of ferrimagnetic materials.

I have found that ferrimagnetic materials are significantly different in chemical composition, method of manufacture and available in shape and size, properties particularly—magnetic, conductivity, enabling detection, abrasiveness—and its affect on machinery wear, shape—resulting in a physical hazard, its ease of compounding at high loadings to produce a unique product that food and pharmaceutical businesses need to eliminate the risks associated with contamination.

The detection device generates a signal that is transmitted to a range of devices to reject the contaminated items. Typical rejection mechanisms include diversion valves, air blowers, push arms, retractable conveyor beds, reversible conveyor beds, slider gates, ink markers, diversion conveyors, robotic grippers and a simple flashing light and stop/start mechanism for manual removal of the item.

### BRIEF DESCRIPTION OF THE DRAWINGS

Illustration of the invention is now described with reference to the accompanying drawings.

Detectable Particles and Their Characteristics

FIGS. 1A, 1B and 1C are photographs of metal filings, swarf and stainless steel powder and referred to in the prior art, U.S. Pat. No. 6,113,482 and U.S. Pat. No. 6,177,113.

FIGS. 2A, 2B and 2C are photographs of magnified magnetite particles.

FIG. 3A is a spin magnetic moment configuration for ferrous metals.

FIG. 3B is a quadrature plot and in phase plot for ferrous metals.

FIG. 3C is an impedance plan response for ferrous metals.

FIG. 4A is an impedance plan response for non ferrous metals.

FIG. 4B is an impedance plan response for non ferrous metals.

FIG. 4C is an impedance plan response for non ferrous metals.

FIG. 5A is an impedance plan response for ferrimagnetic ceramics.

FIG. 5B is an impedance plan response for ferrimagnetic ceramics.

FIG. 5C is an impedance plan response for ferrimagnetic ceramics.

FIG. 5D is an impedance plan response for wet product.

FIG. 6 is a diagram of the elementary magnetic dipoles orientation influenced by interatomic exchange coupling in metals and metal oxides.

FIG. 7 is a perspective of a materials handling crate made with magnetite homogeneously dispersed in a polypropylene base as per Example 1.

FIG. 8 is an example of a meat tray undergoing metal detection on a conveyor.

FIG. 9 is a perspective of a HDPE/LLDPE plastic film as per Example 2 forming part of a plastic bag.

FIG. 10 is a diagram showing approximate particle size and shape versus film thickness.

FIG. 11 is a diagram of a simple mitred elastomer seal as per Example 3 on the side of a fragment of pressing board.

FIG. 12 is a diagram of a mechanical diverter.

FIG. 13 is a diagram of a pneumatic diverter.

### DETAILED DESCRIPTION WITH RESPECT TO THE DRAWINGS

Detectable Particles

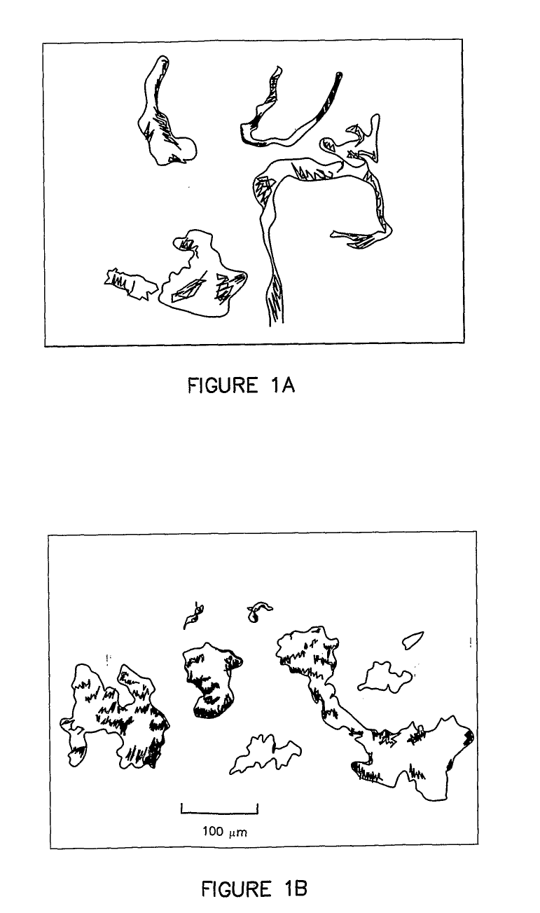

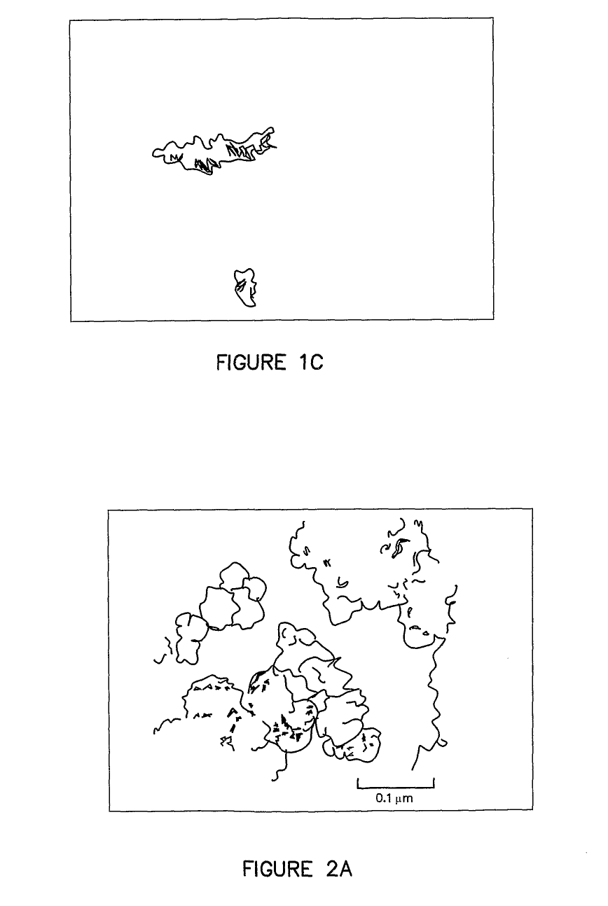

FIGS. 1A, 1B and 1C are photographs of swarf; stainless steel powder and metal filings as used in the prior art U.S. Pat. No. 6,113,482 and U.S. Pat. No. 6,177,113. The photographs illustrate the irregular shape of the material which pose an invasive physical hazard on ingestion or external contact, in addition contribute to blockage of screen packs on film extrusion lines.

Metal particles can be manufactured by mechanical abrasion to form swarf or filings. Metal powders can be manufactured by blowing molten metal into a cool air stream to solidify the metal. Both methods produce particles that are abrasive and physically abrasive. Metals do not bond strongly to the plastic or rubber which is why they are moulded in metal dies. As a result they can abrade into the food items as very fine slivers.

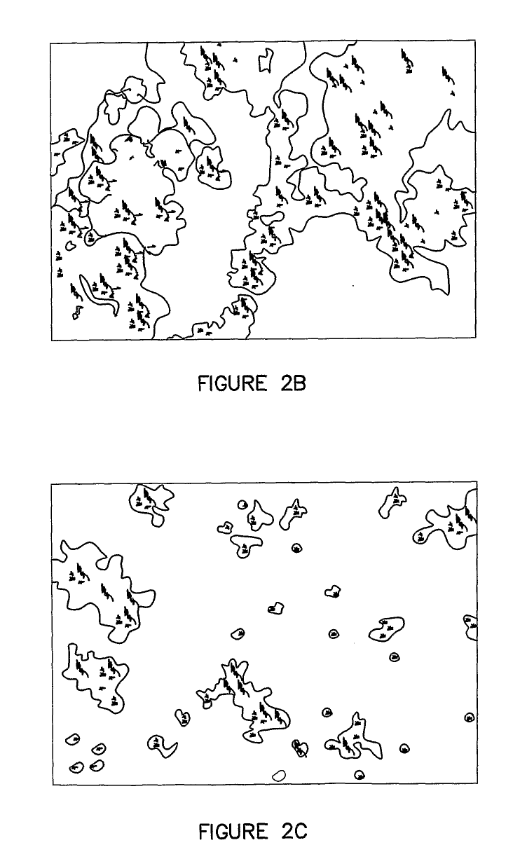

FIGS. 2A, 2B and 2C illustrate the rounded shape of the mineral magnetite, which is non-toxic and not physically invasive as compared to the particles in FIG. 1. Ferrites are either ground to a fine powder or can be formed by precipitation. If a particle of magnetite does abrade, its shape and size does not present a safety risk. The particles agglomerate because of the magnetic attraction.

Food manufacturers found they could reduce the risk of plastic contamination to some extent by the use of metal based detectable plastic, but only by the addition of the risk of metal contamination.

Food manufacturers welcome the possibility to eliminate the risk of metal as a contaminant altogether while still being able to detect the plastic or elastomer by using detectable ferrite based plastic.

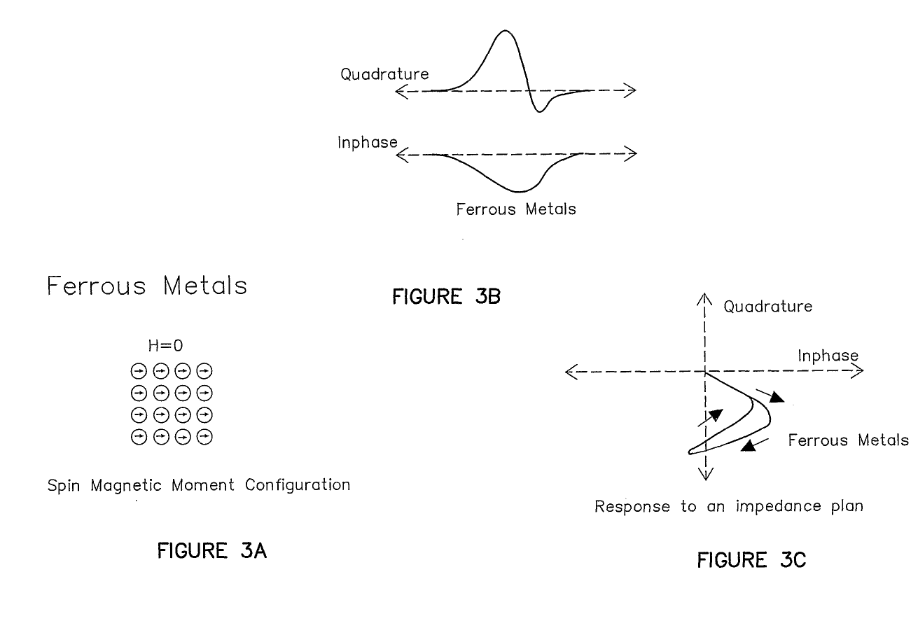

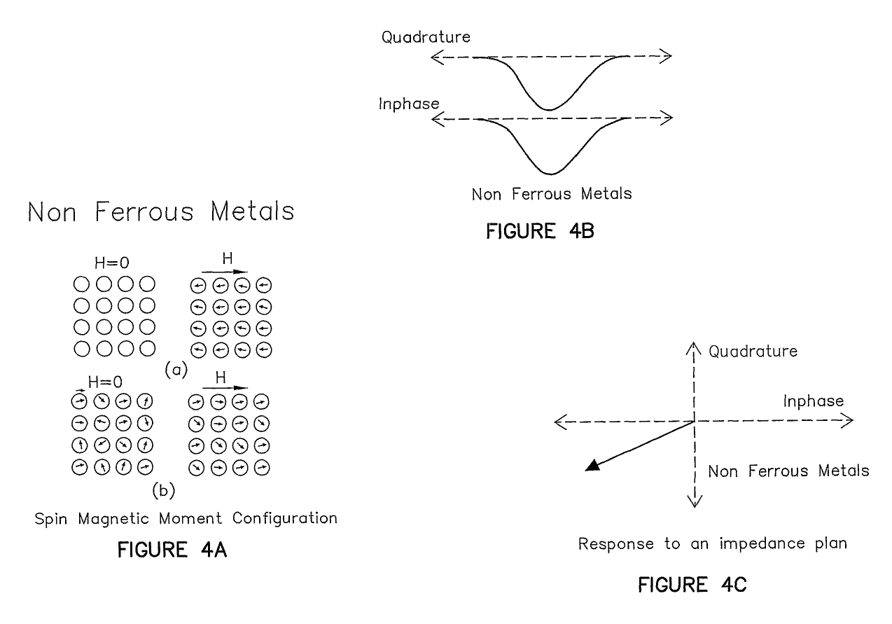

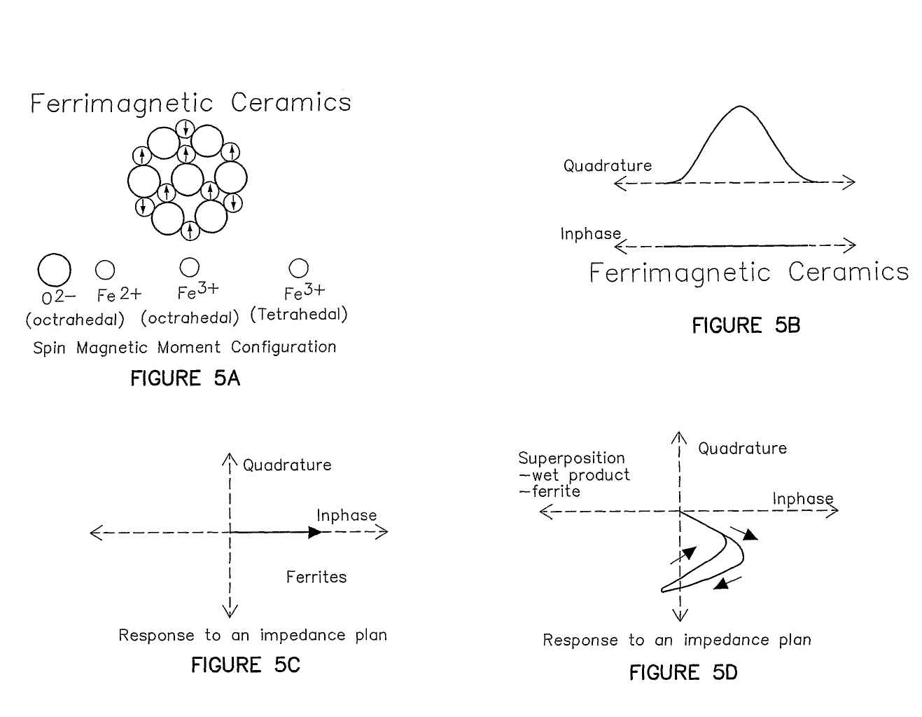

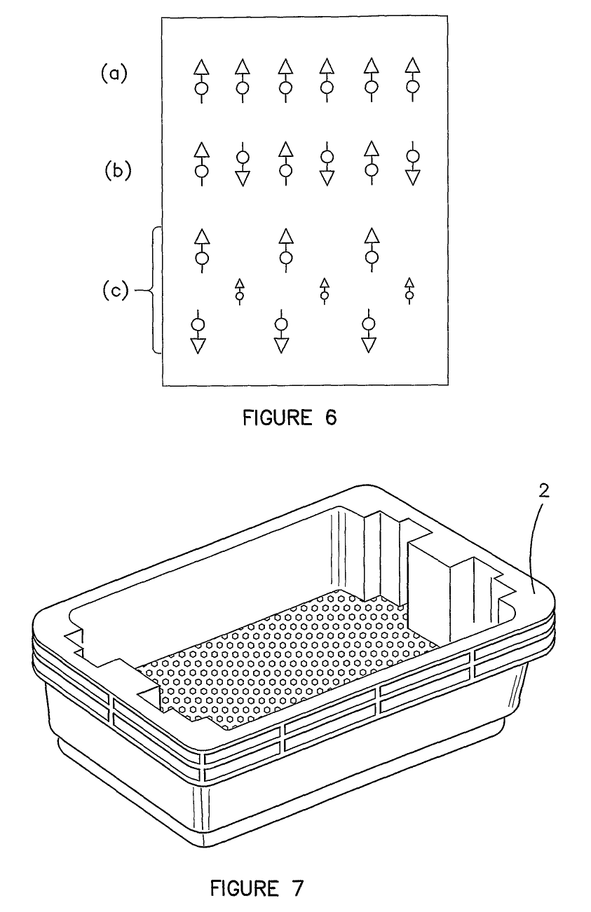

FIGS. 3A-3C and FIGS. 4A-4C illustrate two of the differences in the fundamental properties of the metal as discussed in the prior art U.S. Pat. No. 6,113,482 and U.S. Pat. No. 6,177,113. FIGS. 5A-5D illustrate the response of ferrimagnetic materials in wet and dry product.

FIG. 6 illustrates the spin magnetic moments of magnetic materials:
(a) Ferromagnetic (eg. metals—Fe, Co, Ni) as used in the prior art U.S. Pat. No. 6,113,482 and U.S. Pat. No. 6,177,113 and shows a mutual alignment of atomic dipoles for a ferromagnetic material.
(b) Antiferromagnetic (eg. ceramic materials—MnO, FeO and MnS). The opposing magnetic moments cancel one another and as a consequence, the solid as a whole possess no net magnetic moment.
(c) Ferrimagnetic (eg. ceramics and ferrites—Fe₃O₄, Fe₂O₃, XO, where X is a divalent metal). As used in this patent application, a net magnetic moment arises from the incomplete cancellation of the spin moments.

FIG. 3A shows the response of a metal detector to a ferrous metal sample, a ferrite sample and a non-ferrous metal sample.

FIG. 4(a) shows the structure and spin magnetic moment (b) signal response (c) plot on an impedance plane for non-ferrous metals. On an impedance plane, the plot is of a straight line whose angle is dependant on the conductivity of the metal.

Metal detectors not only detect conductive metal objects they also detect any other conducting object, such as wet foods, hot bread, meat, cheese or even your hand. Although weakly conductive, the size and mass of the food produces a significant signal response. This is called a product effect which the detector using filters and discrimination tune out, resulting in a loss of sensitivity.

To improve the signal response ferrous, metals Fe, Ni, Co are used which are classified as Ferromagnetic. This results in a conductive and magnetic response as shown in FIG. 3.

In this case the response on an impedance plane is a loop due to the superposition of both effects. Typically Mild Steel which is ferrous can be detected to a 1 mm sphere in size. Stainless Steel 316 which is non-Ferrous alloy used for vessels and other equipment items in the food industry, can be detected to a sphere of 2 mm in size.

By comparison the Ferrimagnetic ceramics produces a markedly different response. Refer to FIG. 5. This results in a horizontal line on the impedance plane as there is no conductive component. The ferritic response is well known to those who use hand held metal detectors for beachcombing, fossicking or mine detection, but not by those in the food industry. The ferritic response is due to the mineralised stone and is known as a ground effect and every effort is made to discriminate or filter it out. This effect is not observed in the food industry where there are no ferrites present or in such a small quantity that it is swamped by the other responses. The ferrimagnetic ceramics exhibit permanent magnetization and it is the this magnetic field that triggers the detection coils.

For wet products containing a polymer/magnetite matrix, there is a superposition of the individual responses for the conductive food and the magnetic response from the magnetite. This results in a loop effect. By characterising the signal of the product free of contamination and the signal of the product with various levels of contamination, contaminated material can be readily rejected. As proposed in U.S. Pat. No. 5,304,927.

The examples below illustrate some applications and their benefits.

Detectable Plastic Crate

FIG. 7 illustrates an application of Example 1 below using Ground Magnetite dispersed in polypropylene to create a materials handling crate 2. Excellent dispersion is achieved. The particles are not visible to the naked eye.

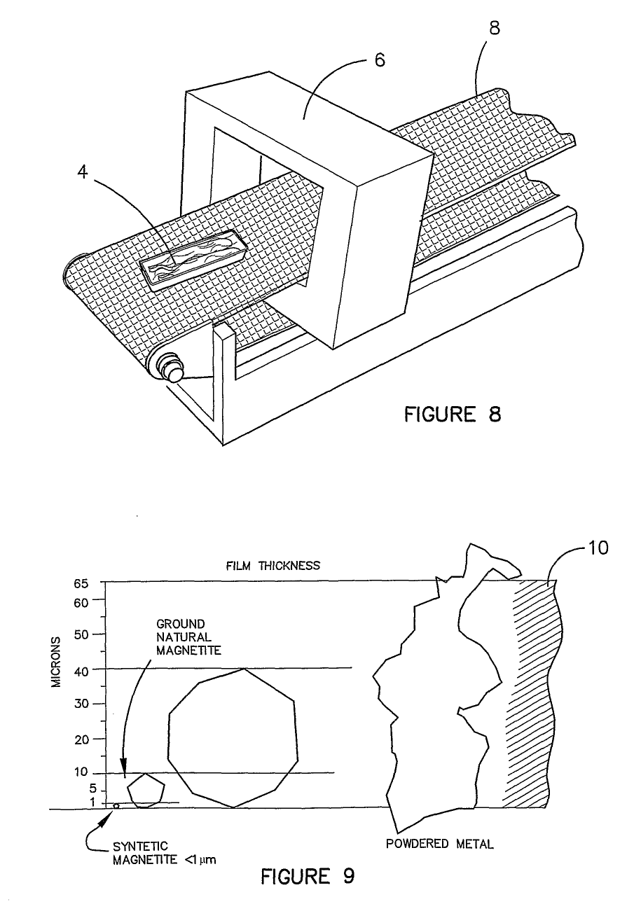

FIG. 8 shows a meat tray 4 about to pass through the aperture of a metal detector 6 while travelling on a conveyor 8.

### EXAMPLE 1

Ground magnetite with a particle size of 0.1-100 μm is mixed with polymer chips and blended to disperse the particles uniformly in the ratio of 20% magnetite and 80% polypropylene. The mix is moulded into a crate 2. The crate 2 may be used to hold cuts of meat, poultry pieces or confectionery. The crates may be emptied mechanically onto conveyors, processing equipment or stacked on each other or pallets for storage.

In a variant, the polypropylene was modified with the addition of rubber to ensure that it failed in a ductile, rather than brittle manner.

Ground magnetite with a particle size of 0.1-100 μm is mixed with polymer chips and blended to disperse the particles uniformly in the ratio of 20% magnetite and 80% rubber modified polypropylene. The material is compounded in a typical thermoplastic screw and barrel compounder. The frictional heat and the heated barrel melt the polymer and the agitation of the screw mix the polymer, the material is extruded into strands, cooled and cut into pellets. The polymer is moulded using a typical injection moulding machine and tool. The frictional heat generated by the screw and the heated barrel liquefy the polymer, which is injected into a metal tool under pressure and cooled to solidify the material to form a crate.

If the crates are abraded or damaged during such handling, small fragments of 3×3×1.5 mm can be readily detected depending on the metal detectors with a large aperture size of 600×350 mm operating at low frequency in a confectionery plant or a meat tray 4 as shown in FIG. 8. Further improvements in the minimum detection size is possible with smaller pipeline detectors.

Detectable Plastic Film

FIG. 10 illustrates an application of Example 2 below of synthetic magnetite mixed with high density polyethylene and linear low density polyethylene to form a plastic film 10.

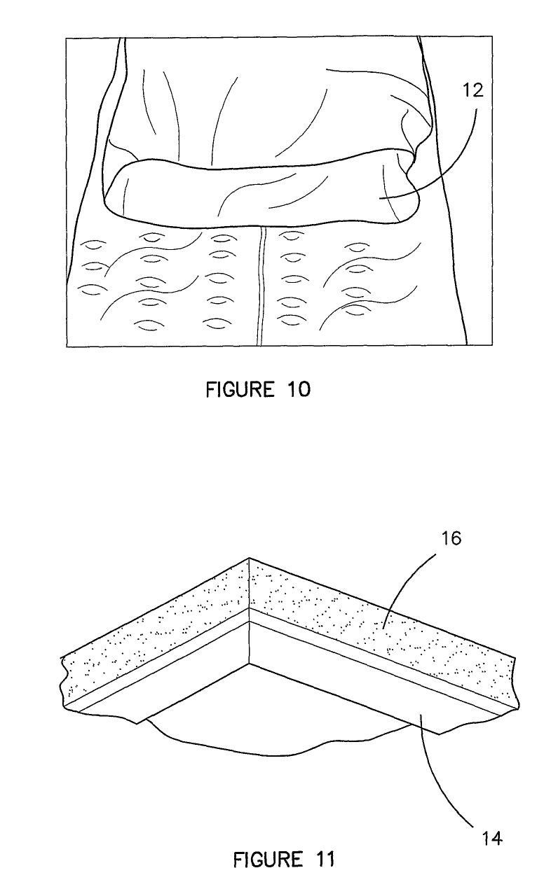

FIG. 9 illustrates the particle size of magnetite used and an example of a metal stainless steel metal powder in the prior art.

### EXAMPLE 2

A proposed embodiment of this invention is the manufacture of detectable film. Coloured films using the mineral Titanium Dioxide (a white pigment, although not detectable) highlight that minerals such as Ferrites like magnetite can be a substitute that could produce a film of similar physical properties. In addition, film processors accustomed to working with minerals are readily convinced that the manufacture of film based on magnetite is feasible and present no processing issues (whereas the use of metal powders was deemed impractical due to abrasion, particle size and shape). Being able to produce ultra fine particles in the range of 0.1-1 μm ensures even dispersion, high loadings and formation of a suitable film with reasonable physical properties. In this example, there is a first compounding stage to prepare a masterbatch, the synthetic magnetite of 0.6 μm is homogeneously dispersed into LLDPE carrier in a double screw compounder with a heated barrel, 70% magnetite and 30% LLDPE. Due to the frictional heat and the heated barrel and the agitation of the screw, the molten LLDPE mixes in with the magnetite, the polymer is extruded out a nozzle to form a thin strand, this is then cooled and cut into pellets. This masterbatch is then added in a further compounding stage similar to above prior to extrusion, 40% masterbatch and 60% HDPE/LLDPE.

The molten polymer is extruded to form a film that has a composition of 28% magnetite and 72% HDPE/LLDPE in a core detectable layer of 40 μm. A boundary layer of 100% HDPE/LLDPE, 10 μm top and bottom produces a 60 μm film in this example is coextruded at the same time. In this particular application, the boundary layer provides strength, tear resistance, chemical resistance and a barrier to oxygen. A sample film is shown in FIG. 10. Relative sizes of the inclusions are seen in FIG. 9.

An application of the film is for a carton liner or plastic crate liner (Example 1) that bulk meat cuts are placed in for storage and shipment to other meat processors at approximately 0° C. The film 10 is designed to replace the current 100% HDPE/LLDPE film that regularly becomes entrapped in the frozen meat and becomes a contaminant. Contaminants can now be detected, preferably in the chute prior to processing after processing or detected in the processed end product, for example a pizza.

Another application example is the use of the film to produce a bag to hold dry powdered product, such as sugar or starch for the confectionary industry (FIG. 10). The bag is typically slit with a sharp knife and decanted into process vessels. Cut pieces of plastic are a common contaminant as a result of this operation.

The plastic film was tested through a large 570 mm×355 mm aperture detector normally used for detecting an entire bag 12 of product for metal fragments and was able to detect a 40 mm×40 mm fragment of the film as per Example 2.

Another application example is of a confectionary processor, whereby a smaller 150 mm pipeline detector was used after the bag is cut and was able to remove pieces of film 10 mm×10 mm as per Example 2. This is equivalent to a 2 mm sphere in volume.

Detectable Rubber Seal

FIG. 11 illustrates an application of Example 3 for an elastomeric seal 14 for a food press. The seal 14 is glued to a board 16.

### EXAMPLE 3

Magnetite is homogeneously dispersed in two part Liquid Polyurethane Rubber in a ratio of 35% Magnetite to 55% Polyurethane part A and B including additional additives. These ingredients are mixed by hand using a spatula in a small beaker until homogeneously dispersed. The material is then poured into a small silicone mould and allowed to cure at approx 40° C. for 1 day. The cured part is then removed by hand and affixed to the mouldboard.

It should be noted other rubbers require specialised heavy duty mixers for thick and viscous rubbers. These are then injection or compression moulded under heat and pressure.

The press seal and mouldings become abraded due to wear during normal use or is occasionally ripped off when a forming tray is misfed into the moulding press. Broken mouldings of 1.5×1.5×1.8 mm or the same volume as a 2 mm sphere can be readily detected in a 150 mm pipeline detector, which is equivalent to a 100% stainless steel part.

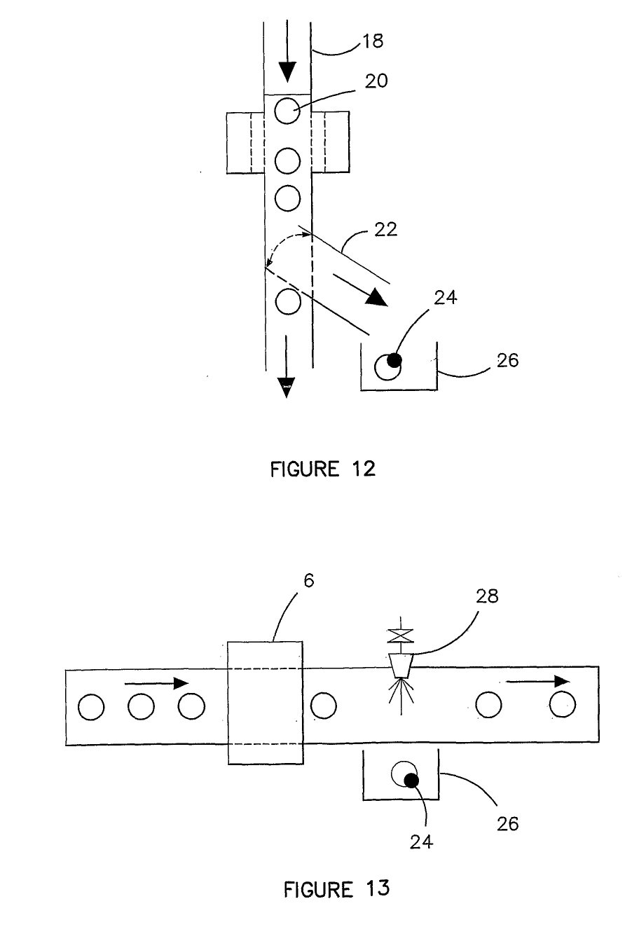

In all three examples, fragments of the crate, film and seal are all capable of generating a signal in a pipeline detector made by Detection Systems Pty. Ltd. of Victoria Australia already in use in the industry. The detector activates a relay which causes a diverter to deposit the food or pharmaceutical pack into a collection box. The collected items may be tested by a repeat passage through the detector or they may be scrapped. Lorenz of Ontario Canada make a range of diverters (FIG. 12) to deflect product into reject bins.

This type of detection and separation is shown diagrammatically in FIGS. 12 and 13. FIG. 12 is a product conduit 18 which leads to product 20 to a diversion flap 22. Metal detector 6 signals the flap when an inclusion 24 is detected in a product item and the valve diverts the item when it arrives at the detector to a reject bin 26.

In FIG. 13 the detector 6 activates an air nozzle 28 which directs an air blast at the detached article.

I have found the advantages of the examples to be:
1. Safety. The mixes from which components, articles and film are manufactured contain no metal and associated “sharp” hazards, but only non-toxic and non invasive ferrimagnetic ceramic such as magnetite, as a result if detection fails the magnetite does not present a chemical or physical risk.
2. Low Cost. The unit cost of the component parts is comparable to existing plastic components. In the design stage, the characteristics are similar to other mineral filled polymers and the shape, size can be adjusted accordingly and/or other additional additives are added to amend physical properties accordingly. As a raw material, the ferrimagnetic ceramic inclusions, such as Magnetite, acts is a low cost filler. During processing, the abrasive characteristics of the mineral filler is similar to the vast array of mineral fillers currently in use and thus present no additional maintenance cost for the compounder or moulder of the polymer.
3. Detection Performance. The ability to incorporate high loadings of ferrimagnetic inclusions, such as magnetite, has enabled detection at a distance that is comparable to 100% metal components. For example, the plastic film 10×10×40 μm and the rubber mouldings 2 mm sphere typical of stainless steel.
4. Application. The exceptionally fine particle size 0.6 μm and rounded particle shape have enabled a true film based product to be developed that is relatively inexpensive and suitable as a disposable item.
5. Financial Risk Exposure. The food processors now have a lower exposure to risk as a result of contamination. They have reduced the potential for personal injury litigation, costs, food recall and associated costs, loss of brand image, loss of supply contracts and loss of consumer sales due to dissatisfaction with the safety of the products. These cost savings it is felt should more than compensate for any increase in costs based on plastics that include ferrimagnetic inclusions.

It is to be understood that the word “comprising” as used throughout the specification is to be interpreted in its inclusive form, ie. use of the word “comprising” does not exclude the addition of other elements.

It is to be understood that various modifications of and/or additions to the invention can be made without departing from the basic nature of the invention. These modifications and/or additions are therefore considered to fall within the scope of the invention.

1-19. (canceled)

20. A method of detecting and removing physical contamination from a food or pharmaceutical product in a product flow, wherein the source of contamination is a product handling equipment having plastic or elastomer parts which contain dispersed particulate magnetic minerals, said method comprising the steps of:
providing a product on a product flow; and a product handling equipment having plastic or elastomer components including dispersed particulate magnetic mineral fillers;
subjecting said product to a metal or magnetic field detecting equipment;
detecting said particulate magnetic mineral fillers in said product from said product flow using said detecting equipment; and
deriving a signal from said detecting equipment and utilizing said signal to divert said product from said product flow.

21. The method as set forth in claim 20, wherein said particulate magnetic mineral filler content is about 10-50%.

22. The method as set forth in claim 21, wherein said particulate magnetic mineral filler content is about 15-40%.

23. The method as set forth in claim 22, wherein said particulate magnetic mineral has a particle size of about 0.1-100μ.

24. The method as set forth in claim 22, wherein said particulate magnetic mineral has a particle size of about 0.5-20μ.

25. The method as set forth in claim 20 further comprising the step of exposing said particulate magnetic mineral filler to a magnetic field prior to said detection step for increasing the detectability of compositions which are made into film and equipment components which contain magnetic mineral fillers.

26. The method as set forth in claim 20, wherein said detecting equipment is selected from the group consisting of a pipeline metal detector and conveyor metal detector.

27. The method as set forth in claim 20, wherein said magnetic mineral is a ferrimagnetic ceramic.

28. A detectable plastic or elastomer component composition for food or pharmaceutical handling equipment, said composition comprising:
a plastic or elastomer; and
10-50% of a mineral filler having a particle size of about 0.1-100 μm.

29. The composition as set forth in claim 28, wherein said mineral filler is a ferrimagnetic material.

30. The composition as set forth in claim 29, wherein said ferrimagnetic material is represented by the formula MFe₂O4 in which M is selected from the group consisting of Fe, Ni, Mn, Co, and Cu.

31. The composition as set forth in claim 29, wherein said ferrimagnetic material is a cubic ferrite.

32. The composition as set forth in claim 29, wherein said ferrimagnetic material is a hexagonal ferrite or garnet.

33. The composition as set forth in claim 28, wherein said particulate magnetic mineral has a particle size of about 0.5-20μ.

34. A method of making a detectable plastic or elastomer component for use with a food or pharmaceutical product, said method comprising the steps of:
mixing a molten polymer into a particulate magnetic mineral filler to form a composition; and
extruding said composition.

35. The method as set forth in claim 34 further comprising the step of coextruding a film of said magnetic mineral composition with a film layer without magnetic mineral filler.

36. The method as set forth in claim 35, wherein said film layer is an oxygen barrier.

37. The method as set forth in claim 35, wherein said molten polymer is a LLDPE carrier, and wherein about 0.6 μm of said particulate magnetic material filler is homogeneously dispersed into said LLDPE carrier to produce about 70% magnetite and about 30% LLDPE.

38. The method as set forth in claim 37, wherein a double screw compounder with a heated barrel is used to disperse said particulate magnetic material filler into said LLDPE carrier.

39. The method as set forth in claim 38, wherein said molten polymer is extruded to form a film that has a composition of about 28% magnetic material and 72% LLDPE in a core detectable layer of 40 μm.
